(19) United States
(12) Patent Application Publication
(10) Pub. No.: US 2015/0092408 A1
(43) Pub. Date: Apr. 2, 2015

(54) LIGHT FIXTURE WITH MOTION SENSOR

(71) Applicant: Capstone Lighting Technologies LLC, Deerfield Beach, FL (US)

(72) Inventor: Stewart Wallach, Deerfield Beach, FL (US)

(73) Assignee: Capstone Lighting Technologies LLC, Deerfield Beach, FL (US)

(21) Appl. No.: 14/041,245

(22) Filed: Sep. 30, 2013

(51) Int. Cl. H05B 37/02; F21V 21/30

(52) U.S. Cl. CPC H05B 37/0227; F21V 21/30
USPC 362/233

(57) ABSTRACT

A light fixture with a motion sensor includes a holder arranged for mounting on either a vertical or a horizontal surface, a head rotatablely connected with the holder, and a motion sensor installed on the holder, the head including a housing, a control circuit board and multiple light bulbs mounted in the housing, the light bulbs and the motion sensor being electrically connected with the control circuit board, the motion sensor being arranged to receive infrared radiation emitted by a human being thereby turning on the light bulbs controlled by the control circuit board. The head is rotatable, thus the illumination angle of the light fixture is wide, and is convenient to operate.

### FIELD OF THE INVENTION

The present invention relates in general to a light fixture, and more particularly to a wireless light fixture with a motion sensor.

### BACKGROUND OF THE INVENTION

The technical of utilizing motion sensor to receive infrared radiation from a human being within a certain distance has been well known for a while. Conventional light fixture with a motion sensor includes a light bulb, and an infrared motion sensor which is mounted on a mounting base and installed adjacent to the light bulb. The infrared motion sensor is responsive to the infrared radiation emitted by humans and turns on the light bulb when it receives the infrared radiation from the humans within a predetermined distance.

Pat. No. CN201196367Y disclosed a light fixture with a motion sensor, as shown in FIG. 1, including a housing with a cover 1 and a base plate 8, a motion sensor 3, a light 4 and a signal processing circuit board 5 that are installed in the housing. There is an opening 11 opened at the top of the cover 1 to expose the sensor 3 and the light 4, and the base plate 8 is mounted on either a wall or a ceiling The sensor 3 is viable to sense a certain sensing area, and the light 4 will be turned on to illuminate the sensing area once a human being enters the sensing area, and will be shut down once the human being is away from the sensing area for a certain time.

However, the light fixture with a motion sensor may just illuminate the sensing area where someone enters, but can not illuminate other areas excluding the sensing area. The illumination angle of the light fixture is narrow, which is not applicable to different situations, and is inconvenient to use.

Thus, a light fixture with a wide illumination angle is needed to overcome the above defect.

### SUMMARY OF THE INVENTION

The objective of the present invention is to provide a light fixture with a wide illumination angle, which is convenient to use.

In order to achieve the above objective, a light fixture with a motion sensor, includes a holder arranged for mounting on either a vertical or a horizontal surface, a head rotatablely connected with the holder, and a motion sensor installed on the holder, the head including a housing, a control circuit board and multiple light bulbs mounted in the housing, the light bulbs and the motion sensor being electrically connected with the control circuit board, the motion sensor being arranged to receive infrared radiation emitted by a human being thereby turning on the light bulbs controlled by the control circuit board.

Compared with the prior art, the light bulbs is turned on when the motion sensor receives infrared radiation from a human being who enters in the sensing area of the motion sensor. However, the infrared radiation fails to be received by the motion sensor when the human being leaves the sensing area, and then the light bulbs are shut down. The light fixture is convenient to use, and is conductive to energy conservation and environmental protection. The head and the holder of the light fixture are connected rotatablely, so the head can be aimed in various directions, with the addition that the motion sensor is connected with the holder, thus, the angle between the head and the motion sensor can be adjusted by rotating the head, the light bulbs of the head not only can light the sensing area of the motion sensor, but also can light other zone excluding the sensing area. Thereby, the illumination angle of the light fixture is wide, which can adapt to different situations.

Concretely, the light fixture further includes a first rotating mechanism configured between the head and the holder, the first rotating mechanism including a first rotating shaft vertically configured between the head and the holder and fixed to one of the head and the holder, and a first protuberance fixed to the other one of the head and the holder, numbers of first recesses being provided around peripheries of the first rotating shaft, and the head being rotatable around the first rotating shaft with 360 degree, the first protuberance being arranged to engage with any one of the first recesses.

Preferably, side walls of the first recess are curved, and the first protuberance is a curved surface appropriate to the side walls of the first recess, thereby the first protuberance being slidable from one of the first recesses to another.

Concretely, the holder includes an upper holder and a lower holder rotatablely connected with the upper holder, and the head rotatablely connected with the upper holder.

Concretely, the light fixture further includes a second rotating mechanism configured between the upper holder and the lower holder, the second rotating mechanism including a first engaging member fixed to one of the upper holder and the lower holder, and a second engaging member fixed to the other one of the upper holder and the lower holder, the first engaging member having a second rotating shaft configured horizontally, the second engaging member sleeving and being rotatable around the second rotating shaft with 90 degree, and two contrate gears being respectively formed on contiguous surfaces of the first engaging member and the second engaging member to engage with each other. The head is rotatable around the first rotating shaft configured vertically, and the upper holder is rotatable around the second rotating shaft configured horizontally, thus, the head can be aimed in various directions so as to light in all directions.

Preferably, an elastic component is disposed between the second engaging member and the upper holder or the lower holder, so as to urge the second engaging member to engage with the first engaging member.

Preferably, the motion sensor is rotatablely connected with the holder.

Concretely, the light fixture further includes a third rotating mechanism configured between the motion sensor and the holder, the third rotating mechanism including a third rotating shaft horizontally configured between the motion sensor and the holder and fixed to one of the motion sensor and the holder, and a second protuberance fixed to the other one of the motion sensor and the holder, numbers of second recesses being provided around peripheries of the third rotating shaft, and the motion sensor being rotatable around the third rotating shaft with 90 degree, the second protuberance being arranged to engage with any one of the second recesses.

Preferably, side walls of the second recess are curved, and the second protuberance has a curved surface appropriate to the side walls of the second recess, thereby the second protuberance being slidable from one of the second recesses to another.

Preferably, the light fixture further including an optical sensor electrically connected with the control circuit board, arranged to detect light intensity and to turn on the light bulbs when a predetermined light intensity is reached and the infrared radiation is received.

Preferably, the light fixture further including a power unit configured in the holder and electrically connected with the control circuit board.

Preferably, the light fixture further includes a low voltage indicator light electrically connected with the power unit, so as to alert the low voltage of the power unit.

Preferably, the control circuit board further includes a timing circuit electrically connected with the motion sensor and the light bulbs, arranged to shut down the light bulbs when a preset time for which the infrared radiation fails to be received by the motion sensor is reached.

Preferably, the control circuit board further includes a switching circuit electrically connected with the motion sensor and the light bulbs.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is an exploded view of a conventional light fixture with a motion sensor;

FIG. 2 is a perspective view of a light fixture with a motion sensor of the present invention;

FIG. 3 is another perspective view of the light fixture of the present invention;

FIG. 4 is an exploded view of the light fixture of the present invention;

FIG. 5 is another exploded view of the light fixture of the present invention;

FIG. 6 is a perspective view of a housing and a first rotating shaft of the light fixture of the present invention; and

FIG. 7 is a third perspective view of the light fixture of the present invention seen from the back side.

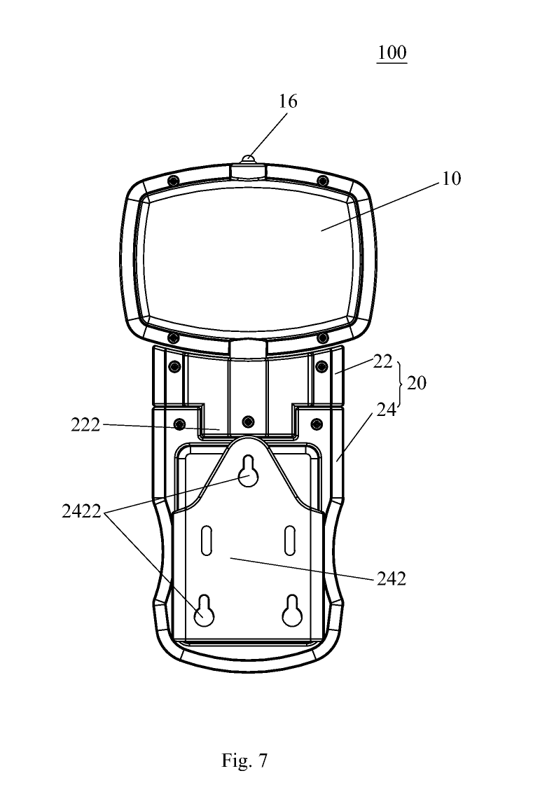

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the present invention is directed to a light fixture with a wide illumination angle, which is convenient to use.

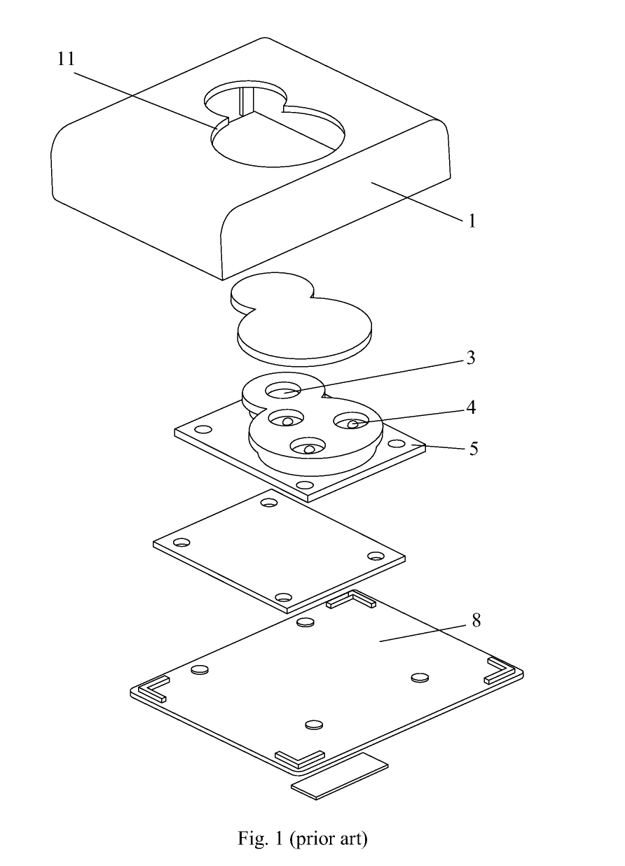

As shown in FIG. 1, a light fixture 100 includes a holder 20 arranged for mounting on either a vertical or a horizontal surface, a head 10 rotatablely connected with the holder 20, and a motion sensor 30 installed on the holder 20. The head 10 includes a housing 12, a control circuit board (not shown) and several light bulbs 14 mounted in the housing 12, the light bulbs 14 and the motion sensor 30 are electrically connected with the control circuit board. The motion sensor 30 is arranged to receive infrared radiation from a human being. The light bulbs 14 are turned on when the motion sensor 30 receives infrared radiation from a human being who enters the sensing area of the motion sensor 30. However, the infrared radiation will not be received by the motion sensor 30 if the human being leaves the sensing area, the light bulbs 14 are shut down. The light fixture 100 is convenient to use, and is conductive to energy conservation and environmental protection. The head 10 and the holder 20 of the light fixture 100 are connected rotatablely, so the head 10 can be aimed in various directions, with the addition that the motion sensor 30 is connected with the holder 20, thus, the angle between the head 10 and the motion sensor 30 can be adjusted by rotating the head 10, and the light bulbs 14 of the head 10 not only can light the sensing area of the motion sensor 30, but also can light other areas excluding the sensing area. Thereby, the illumination angle of the light fixture 100 is wide, which is applicable to different situations.

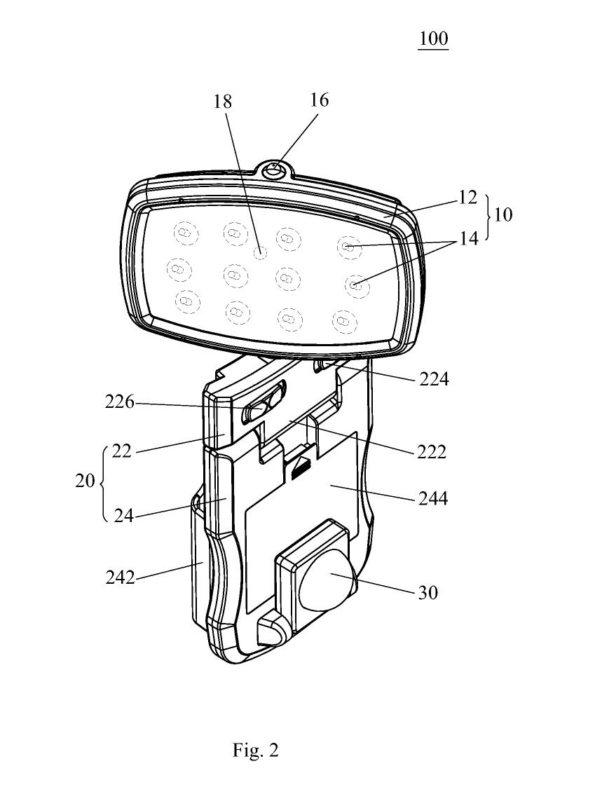

As shown in FIGS. 1 and 2, the holder 20 includes an upper holder 22 and a lower holder 24 rotatablely connected with the upper holder 22, the head 10 rotatablely connected with the upper holder 22. The rotating direction of the upper holder 22 relative to the lower holder 24 is perpendicular to the rotating direction of the head 10 relative to the upper holder 22. Two preferred embodiments of rotating mechanisms configured between the head 10 and the upper holder 22, and between the upper holder 22 and the lower holder will now be described as following.

### The First Embodiment

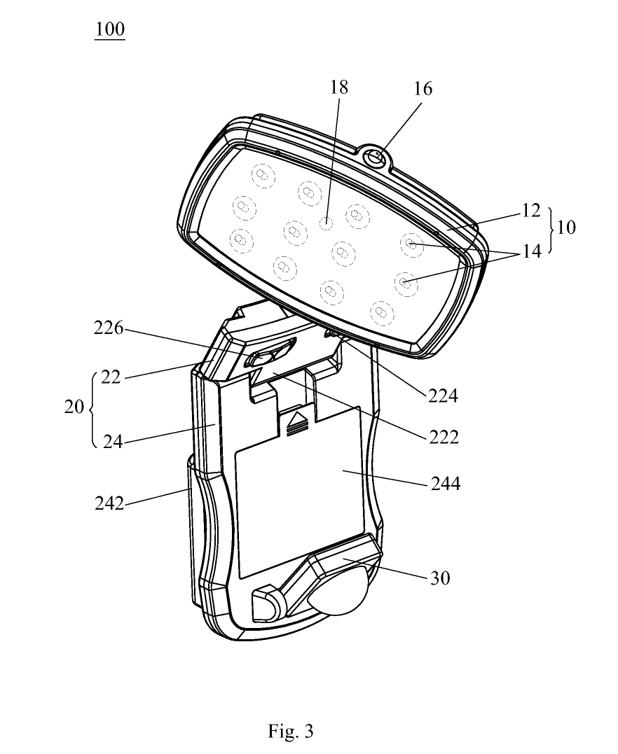

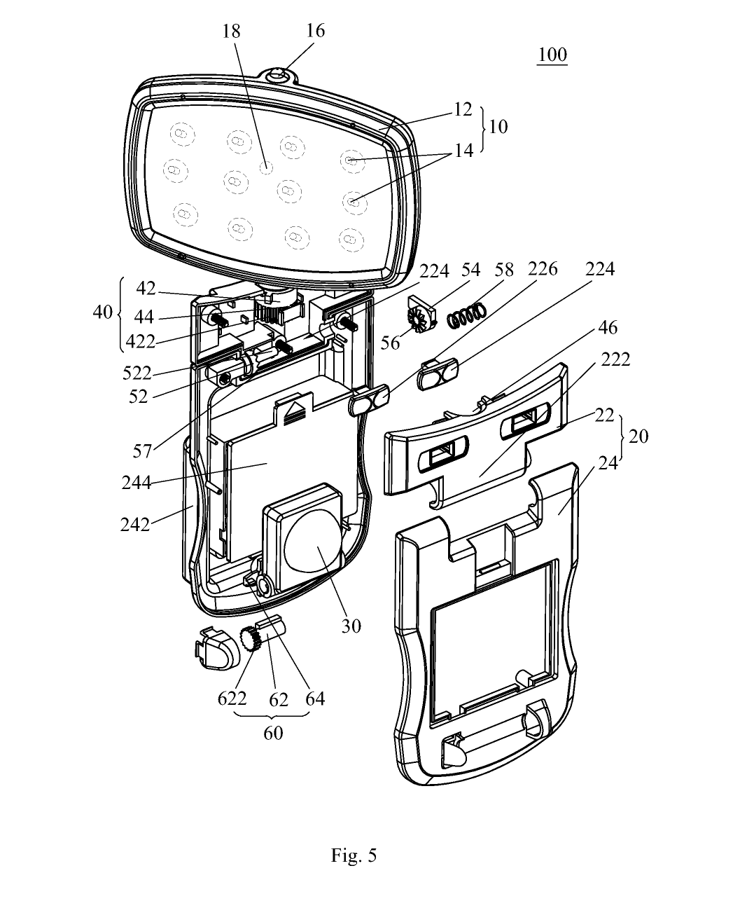

As shown in FIGS. 3 to 5, the shapes of the head 10 and the holder 20 are roughly square. The head 10 is located on the top of the holder 20 if the holder 20 is mounted on a vertical wall. A first rotating mechanism 40 is configured between the head 10 and the holder 20, so as to rotate the head 10 relative to the upper holder 22. The first rotating mechanism 40 includes a first rotating shaft 42 vertically configured between the head 10 and the upper holder 22 and fixed to one of the head 10 and the upper holder 22, and a first protuberance 44 fixed to the other one of the head 10 and the upper holder 22. In this embodiment, the first rotating shaft 42 extends downward from the lower end of the head 10, and numbers of first recesses 422 are formed around peripheries of the first rotating shaft 42. Accordingly, an accommodating hole 46 is opened at the upper holder 22 so as to accommodate the first rotating shaft 42. The first protuberance 44 is fixedly connected with the upper holder 22, preferably, the first protuberance 44 and the upper holder 22 are formed integrally, and can engages with any one of the first recesses 422.

Concretely, side walls of the first recess are curved, and the surface of the first protuberance has a curved surface appropriate to the side walls of the first recess, so that the first protuberance can readily slide from one of the first recesses to another readily so as to adjust the rotating position of the head 10 relative to the holder, which is easy to operate. The head 10 is rotatable around the first rotating shaft 42 with 360 degree.

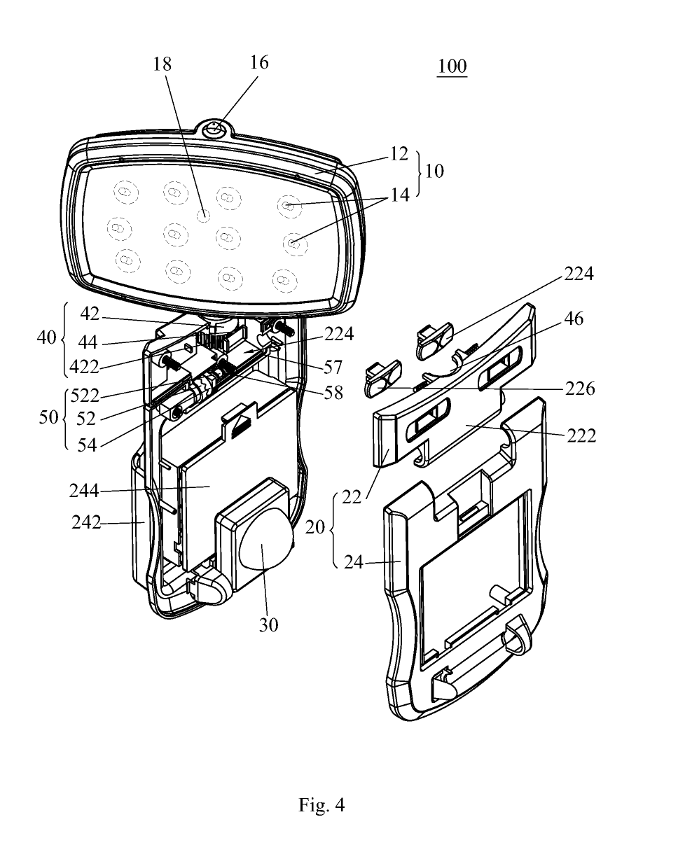

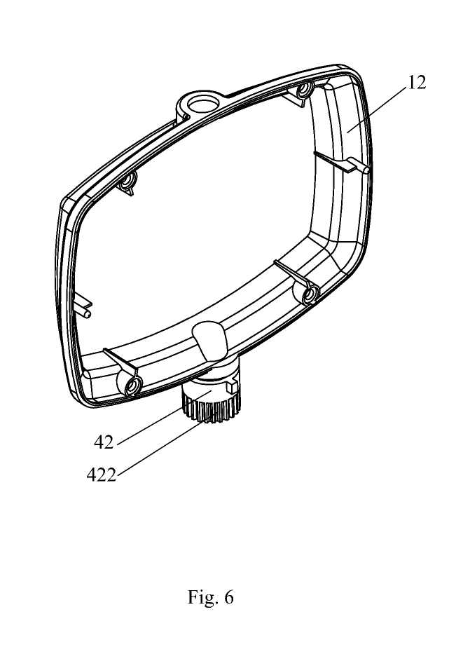

As shown in FIGS. 3 and 4, a second rotating mechanism 50 is configured between the upper holder 22 and the lower holder 24, the second rotating mechanism 50 includes a first engaging member 52 fixed to one of the upper holder 22 and the lower holder 24, and a second engaging member 54 fixed to the other one of the upper holder 22 and the lower holder 24, the first engaging member 52 has a second rotating shaft 522 configured horizontally, the second engaging member 54 sleeves and is rotatable around the second rotating shaft 522 with 90 degree, and two coupled contrate gears 56 are respectively formed on contiguous surfaces of the first engaging member 52 and the second engaging member 54. In this embodiment, the lower end 222 of the upper holder 22 is connected to the upper end of the lower holder 24, concretely, an accommodating recess 57 is formed by caving part of top wall of the lower holder 24, the upper holder 22 is in a shape of ‘T’, the lower end 222 of the upper holder 22 is inserted in the accommodating recess 57. The lower end 222 has a hollow structure that constitutes an accommodating space 224, the first engaging member 52 is fixedly connected to the lower holder 24, and extends into the accommodating space 224 through the accommodating recess 57. The second engaging member 54 is connected with the upper holder 22, and can be rotated along with the upper holder 22 synchronously, at the same time, can slide along the second rotating shaft 522 so as to engage or disengage with the first engaging member 52. Furthermore, an elastic component 58, such as a spring, is disposed between the second engaging member 54 and side wall of the accommodating space 224, so as to drive the contrate gear 56 of the second engaging member 54 to engage with the contrate gear 56 of the first engaging member 52. When the head 10 is rotated, the second engaging member 54 is rotated along with the head 10, and meanwhile presses the elastic component 58 and then slides along the second rotating shaft 522 so as to disengage the two contrate gear 56. If the head 10 continues to be rotated, the two contrate gear 56 can engage each other again, which is easy to operate. The head 10 is rotatable around the first rotating shaft 42 configured vertically, and the upper holder 22 is rotatable around the second rotating shaft 522 configured horizontally, thus, the head 10 can be aimed in various directions so as to light in all directions. As shown in FIG. 6, a mounting member 242 is separably configured at the back of the lower holder 24, and at least one mounting hole 2422 is opened on the mounting member 242 for connecting nail(s) on the wall.

### The Second Embodiment

The structure of this embodiment is similar to that of the first embodiment, the only difference thereof is that the first rotating mechanism 40 between the head 10 and the upper holder 22 is replaced by the second rotating mechanism 50, and the second rotating mechanism 50 between the upper holder 22 and the lower holder 24 is replaced by the first rotating mechanism 40. The replacement of the first rotating mechanism 40 and the second rotating mechanism 50 also can realize that the head 10 lights the environment in all directions. Because the people in this art can easily interchange the first rotating mechanism 40 and the second rotating mechanism 50 if has well known the above technical solution, so no longer repeat here.

As shown in FIGS. 1 and 2, the motion sensor 30 is rotatablely connected to the front of the lower holder 24. Concretely, as shown in FIGS. 3 and 4, a third rotating mechanism 60 configured between the motion sensor 30 and the lower holder 24, the third rotating mechanism 60 includes a third rotating shaft 62 horizontally configured between the motion sensor 30 and the lower holder 24 and fixed to one of the motion sensor 30 and the lower holder 24, and a second protuberance 64 fixed to the other one of the motion sensor 30 and the lower holder 24. In this embodiment, the third rotating shaft 62 is configured at the lower end of the motion sensor 30, and the motion sensor 30 is rotatable around the third rotating shaft 62 with 90 degree. As shown in FIG. 1, the back of the motion sensor 30 and the front of the lower holder 24 fit closely, the motion sensor 30 can receive infrared radiation emitted by humans in its sensing area, while the scope of the sensing area is limited, the angle of which is less than 120 degree, and the radius of which is less than 5 meter. Thus, when the light fixture 100 is installed at a higher position, the motion sensor 30 should be rotated from the vertical position (as shown in FIG. 1) to a horizontal position with 90 degree, or to an oblique position (as shown in FIG. 2) with less than 90 degree, so that the sensing area of the motion sensor 30 can cover all areas under the light fixture 100 including the area close to the wall. Numbers of second recesses 622 are provided around peripheries of the third rotating shaft 62, the second protuberance 64 is fixedly connected to the lower holder 24 and can engages with any one of the second recesses 622. Preferably, side walls of the second recess 622 are curved, and the surface of the second protuberance 64 has a curved surface appropriate to the side walls of the second recess 622, so that the first protuberance can readily slide from one of the first recesses to another readily so as to adjust the rotating position of the head 10 relative to the holder, which is easy to operate.

As shown in FIGS. 1 to 4, the control circuit board further includes a switching circuit electrically connected with the motion sensor 30 and the light bulbs 14. A first control button 224 can slide on the upper holder 22 so as to be selectively located at any one of there positions (a close position, an open position and an auto-induction position). The first control button 224 is connected with the switching circuit and turns on or shuts down the light bulbs 14 through the switching circuit. Concretely, when the first control button 224 is located at the close position, the switching circuit shuts down the light bulbs 14 permanently, while when the first control button 224 is located at the open position, the switching circuit turns on the light bulbs 14 permanently, these two positions will not be detailed here. When the first control button 224 is located at the auto-induction position, and infrared radiation from humans is received by the motion sensor 30, the switching circuit turns on the light bulbs 14, and the embodiments mentioned-above are based on the auto-induction position.

Preferably, the control circuit board further includes a timing circuit electrically connected with the motion sensor 30 and the light bulbs 14. A second control button 226 is connected with the timing circuit and can slide on the upper holder 22, and the second button 226 can select different preset time, such as 20 seconds, 60 seconds, or 90 seconds. The timing circuit shuts down the light bulbs 14 when the preset time for which the infrared radiation from the humans fails to be received by the motion sensor 30 is reached.

Preferably, the light fixture 100 further includes an optical sensor 16 electrically connected with the control circuit board, the optical sensor 16 is configured on the top of the head 10 and arranged to detect light intensity. The control circuit board turns on the light bulbs 14 when a predetermined light intensity detected by the optical sensor 16 is reached and the infrared radiation from the humans is received by the motion sensor 30. Thereby, when the light intensity detected is higher than the predetermined light intensity, the light bulbs 14 won't be turned on even the motion sensor 30 receives infrared radiation from the humans, which is conductive to energy conservation and environmental protection.

Preferably, the light fixture 100 further includes a power unit configured in the lower holder 24 and electrically connected with the control circuit board, so as to supply power for the light bulbs 14.

Preferably, the light fixture 100 further includes a low voltage indicator light 18 electrically connected with the power unit, so as to alert the low voltage of the power unit. The low voltage indicator light 18 is configured on the head 10, and the power unit can be replaced or charged by removing the cover 244.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A light fixture with a motion sensor, comprising:
a holder, arranged for mounting on either a vertical or a horizontal surface,
a head rotatablely connected with the holder, comprising a housing, a control circuit board and multiple light bulbs mounted in the housing, the light bulbs being electrically connected with the control circuit board, and
a motion sensor installed on the holder and electrically connected with the control circuit board, arranged to receive infrared radiation emitted by a human being thereby turning on the light bulbs controlled by the control circuit board.

2. The light fixture with a motion sensor according to claim 1, further comprising a first rotating mechanism configured between the head and the holder, the first rotating mechanism comprising:
a first rotating shaft vertically configured between the head and the holder and fixed to one of the head and the holder, numbers of first recesses being provided around peripheries of the first rotating shaft, and the head being rotatable around the first rotating shaft with 360 degree, and
a first protuberance fixed to the other one of the head and the holder, arranged to engage with any one of the first recesses.

3. The light fixture with a motion sensor according to claim 2, wherein side walls of the first recess are curved, and the first protuberance has a curved surface appropriate to the side walls of the first recess, thereby the first protuberance being slidable from one of the first recesses to another.

4. The light fixture with a motion sensor according to claim 1, wherein the holder comprises an upper holder and a lower holder rotatablely connected with the upper holder, and the head is rotatablely connected with the upper holder.

5. The light fixture with a motion sensor according to claim 4, further comprising a second rotating mechanism configured between the upper holder and the lower holder, the second rotating mechanism comprising:
a first engaging member fixed to one of the upper holder and the lower holder, which has a second rotating shaft configured horizontally, and
a second engaging member fixed to the other one of the upper holder and the lower holder, which sleeves and is rotatable around the second rotating shaft with 90 degree, and two contrate gears being respectively formed on contiguous surfaces of the first engaging member and the second engaging member to engage with each other.

6. The light fixture with a motion sensor according to claim 5, wherein an elastic component is disposed between the second engaging member and the upper holder or the lower holder, so as to urge the second engaging member to engage with the first engaging member.

7. The light fixture with a motion sensor according to claim 1, wherein the motion sensor is rotatablely connected with the holder.

8. The light fixture with a motion sensor according to claim 7, further comprising a third rotating mechanism configured between the motion sensor and the holder, the third rotating mechanism comprising:
a third rotating shaft horizontally configured between the motion sensor and the holder and fixed to one of the motion sensor and the holder, numbers of second recesses being provided around peripheries of the third rotating shaft, and the motion sensor being rotatable around the third rotating shaft with 90 degree, and
a second protuberance fixed to the other one of the motion sensor and the holder, arranged to engage with any one of the second recesses.

9. The light fixture with a motion sensor according to claim 2, wherein side walls of the second recess are curved, and the second protuberance has a curved surface appropriate to the side walls of the second recess, thereby the second protuberance being slidable from one of the second recesses to another.

10. The light fixture with a motion sensor according to claim 1, further comprising an optical sensor electrically connected with the control circuit board, arranged to detect light intensity and to turn on the light bulbs when a predetermined light intensity is reached and the infrared radiation is received.

11. The light fixture with a motion sensor according to claim 1, further comprising a power unit configured in the holder and electrically connected with the control circuit board.

12. The light fixture with a motion sensor according to claim 11, further comprising a low voltage indicator light electrically connected with the power unit, so as to alert the low voltage of the power unit.

13. The light fixture with a motion sensor according to claim 1, wherein the control circuit board further comprises a timing circuit electrically connected with the motion sensor and the light bulbs, arranged to shut down the light bulbs when a preset time for which the infrared radiation fails to be received by the motion sensor is reached.

14. The light fixture with a motion sensor according to claim 1, wherein the control circuit board further comprises a switching circuit electrically connected with the motion sensor and the light bulbs.
